(19) United States
(12) Patent Application Publication
(10) Pub. No.: US 2014/0214431 A1
(43) Pub. Date: Jul. 31, 2014

(54) SAMPLE RATE SCALABLE LOSSLESS AUDIO CODING

(71) Applicants: Mark S. Vinton, San Francisco, CA (US); Charles Q. Robinson, Piedmont, CA (US)

(72) Inventors: Mark S. Vinton, San Francisco, CA (US); Charles Q. Robinson, Piedmont, CA (US)

(73) Assignee: DOLBY LABORATORIES LICENSING CORPORATION, San Francisco, CA (US)

(21) Appl. No.: 14/126,895

(22) PCT Filed: Jun. 27, 2012
(86) PCT No.: PCT/US12/44336

§ 371 Date: Dec. 17, 2013

Related U.S. Application Data
(60) Provisional application No. 61/504,005, filed on Jul. 1, 2011.
(60) Provisional application No. 61/636,516, filed on Apr. 20, 2012.

(51) Int. Cl. G10L 19/00

(52) U.S. Cl. CPC G10L 19/0017
USPC 704/500

(57) ABSTRACT

A transmitter in an audio coding system generates an encoded audio signal that conveys a losslessly encoded representation of an audio signal at a first sample rate and losslessly encoded representations of related audio information at other sample rates. A companion receiver with limited computational resources can generate a high-quality output audio signal at a desired sample rate by losslessly decoding the encoded representation of the audio signal and possibly other portions of the encoded audio signal as needed to obtain an output signal at one of the other sample rates.

### CROSS-REFERENCE TO RELATED APPLICATIONS

This application claims priority to U.S. Provisional Application No. 61/504,005 filed 1 Jul. 2011 and U.S. Provisional Application No. 61/636,516 filed 20 Apr. 2012, both of which are hereby incorporated by reference in entirety for all purposes.

### TECHNICAL FIELD

The present invention pertains to methods and devices that may be used to encode audio signals and to decode encoded audio signals.

### BACKGROUND ART

The computational resources needed in a receiver to decode and process an encoded audio signal are directly affected by the number of audio channels and the sample rate of the audio signal in each channel. Two channel signals with sample rates equal to or less than 44.1 kHz have been used in many applications such as those that process audio information stored on compact discs but current developments indicate that some future applications will process many more channels at much higher sample rates. In digital cinema applications, for example, it is anticipated that a receiver may need to process 128 or more channels at sample rates of 96 kHz or higher. The large number of channels and the high sample rates are likely to require more computational resources in a receiver than is economically attractive.

The amount of computational resources that are needed in a receiver can be reduced by having the receiver convert its decoded audio signal to a lower sample rate as early in the decoding process as possible so that subsequent operations in the process can be performed more efficiently. This approach is not attractive because the computational resources needed to perform a high-quality conversion of sample rate would likely offset most if not more than the reduction achieved for the subsequent portion of the decoding process.

The amount of computational resources that are needed in a receiver can be reduced by having the transmitter convert to a sample rate that is low enough to be processed by the least-capable receiver in the coding system. This approach has a serious disadvantage because all receivers in the coding system would be forced to process low sample-rate signals regardless of the amount of computational resources they possess. A receiver could convert the decoded audio signals to a higher rate but the conversion would not recover the full level of quality of the original high sample-rate signal. Furthermore, the receiver would require significant computational resources to perform a high-quality conversion in sample rate as mentioned above. Alternatively, the transmitter could generate multiple versions of an encoded audio signal for different sample rates but this approach would create new problems in encoded signal distribution and storage.

### DISCLOSURE OF INVENTION

It is an object of the present invention to provide a way for a coding system to generate an encoded audio signal that can be processed efficiently by a receiver to deliver an output audio signal with a sample rate that is commensurate with its computational resources.

This object is achieved by methods and devices that implement various aspects of the present invention. A transmitter generates an encoded output signal that conveys encoded representations of an audio signal at different sample rates. The representations at different sample rates can be prepared in the transmitter using computationally intensive, very high-quality sample-rate conversion methods. Each encoded representation is generated in a form that can be decoded very efficiently. A receiver can decode only those portions of the encoded signal that are needed to obtain an audio signal with a desired sample rate.

A receiver that has very limited computational resources can perform only those processes that are needed to generate an audio signal with a relatively low sample rate. A receiver that has more extensive computational resources can perform those processes that are needed to generate an audio signal with a higher sample rate. As a result, a receiver can decode and process higher quality audio signals at a sample rate that is appropriate for the amount of computational resources that are available.

According to one aspect of the present invention, a transmitter encodes an audio signal by obtaining a first signal comprising digital samples that represent the audio signal at a first sample rate; obtaining one or more additional signals each comprising digital samples that represent the audio signal at a sample rate that differs from and is higher than the first sample rate; generating one or more difference signals, each difference signal comprising samples that represent a difference between a respective additional signal and the first signal converted to a sample rate equal to the sample rate of the respective additional signal; applying a first lossless encoder to the first signal to generate a first encoded signal comprising samples representing the audio signal at the first sample rate, wherein the first lossless encoder adapts its operation in response to first coding parameters; applying one or more additional lossless encoders to the one or more difference signals to generate one or more additional encoded signals, where a respective additional lossless encoder is applied to a respective one of the difference signals to generate a respective additional encoded signal comprising samples that represent the respective difference signal at its sample rate, and wherein the respective additional lossless encoder adapts its operation in response to associated coding parameters; and generating an encoded output signal that conveys the first encoded signal, the one or more additional encoded signals, and representations of the first coding parameters and the coding parameters associated with the one or more additional lossless encoders.

According to another aspect of the present invention, a receiver decodes an encoded audio signal by receiving the encoded audio signal that conveys a first encoded signal comprising samples that represent audio information at a first sample rate, one or more additional encoded signals each comprising samples that each represent audio information at a different sample rate and that is higher than the first sample rate, first coding parameters that was used by a lossless encoder to generate the first encoded signal, and coding parameters associated with one or more additional lossless encoders that were used to generate the one or more additional encoded signals; processing the encoded audio signal to obtain the first encoded signal, the first coding parameters, at least some additional encoded signals and corresponding coding parameters for each additional lossless encoder that was used to generate the at least some additional encoded signals; generating a first signal by applying a first lossless decoder to the first encoded signal, wherein the first lossless decoder adapts its operation in response to the first coding parameters; generating one or more additional signals by applying a respective additional lossless decoder to each of the at least some additional encoded signals, wherein the respective lossless decoder adapts its operation in response to associated coding parameters; generating one or more summation signals, each respective summation signal representing a sum of a respective additional signal and the first signal converted to a sample rate equal to the sample rate of the respective additional signal; and generating an output signal from at least one signal in a set of signals comprising the first signal and the one or more summation signals, wherein the first signal comprises digital samples that represent an audio signal the first sample rate and each respective summation signal comprises digital samples that represent the audio signal at a respective sample rate that is not equal to the first sample rate.

The various features of the present invention and preferred implementations may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIG. 1 is a schematic block diagram of a device that may be used to encode an audio signal according to various aspects of the present invention.

FIG. 2 is a schematic block diagram of a device that may be used to decode an encoded audio signal according to various aspects of the present invention.

FIG. 3 is a schematic block diagram of a device that may be incorporated into the device illustrated in FIG. 1.

FIG. 4 is a schematic block diagram of an exemplary implementation of a lossless encoder that may be used in the device illustrated in FIG. 1.

FIG. 5 is a schematic block diagram of an exemplary implementation of a lossless decoder that may be used in the device illustrated in FIG. 2.

FIG. 6 is a schematic block diagram of a device that may be used to implement various aspects of the present invention.

### MODES FOR CARRYING OUT THE INVENTION

### A. Introduction

1. Transmitter

a) Basic Implementation

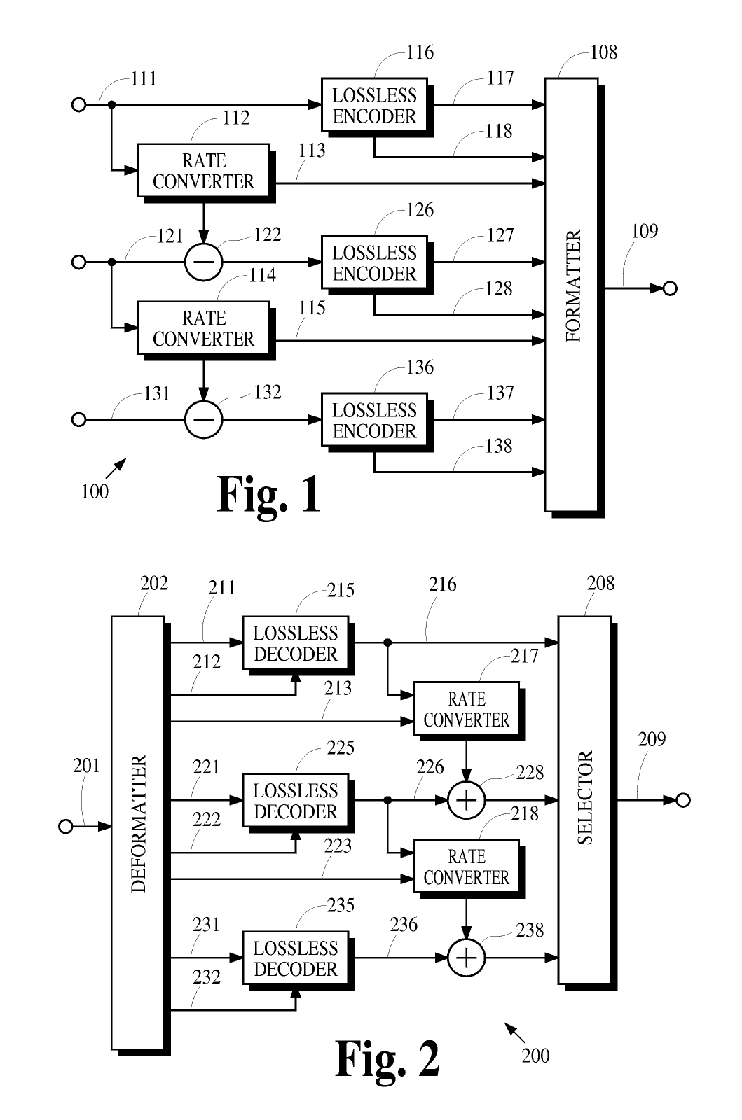

FIG. 1 is a schematic block diagram of one implementation of a transmitter for encoding an audio signal that incorporates various aspects of the present invention. Some features illustrated in the figure are optional.

In one variation of this implementation, the transmitter 100 obtains a first signal from the path 111 and a second signal from the path 121. The first signal comprises digital samples that represent the audio signal at a first sample rate, such as 48 kHz for example. The second signal comprises digital samples that represent the audio signal at a second sample rate that is higher than the first sample rate, such as 96 kHz for example. These two signals are processed as described below to generate an encoded signal that can be subsequently decoded in a receiver to recover an exact replica of the first signal, the second signal, or both of these two signals.

The rate converter 112 converts the first signal into a first interim signal comprising digital samples at the second sample rate.

The subtractor 122 generates a first difference signal comprising samples at the second sample rate by calculating a difference between corresponding samples of the second signal and the first interim signal.

The lossless encoder 116 is applied to the first signal to generate a first encoded signal, which is passed along the path 117 to the formatter 108. This first encoded signal comprises samples that represent the first signal at the first sample rate. The lossless encoder 116 adapts its operation in response to first coding parameters whose values can be adjusted to optimize encoder performance. The first coding parameters are passed along the path 118 to the formatter 108.

The lossless encoder 126 is applied to the first difference signal received from the subtractor 122 to generate a second encoded signal, which is passed along the path 127 to the formatter 108. The second encoded signal comprises samples that represent the first difference signal at the second sample rate. The lossless encoder 126 adapts its operation in response to second coding parameters whose values can be adjusted to optimize encoder performance. The second coding parameters are passed along the path 128 to the formatter 108.

The formatter 108 assembles the first encoded signal, the second encoded signal, and data representing the first coding parameters and the second coding parameters into an encoded output signal that is suitable for transmission or storage. This may include error detection-correction codes, communication synchronization words and coding metadata for use in decoding the signal. These details may be important in practical implementations but they are not critical in principle to the present invention. The encoded output signal is passed along the path 109 for transmission or storage.

b) Additional Features and Variations

Operation of the rate converter 112 may be adapted if desired. If the operation is adapted, parameters that define the operational characteristics are passed along the path 113 to the formatter 108 for assembly into the encoded output signal.

If desired, the transmitter 100 may process three or more signals having different sample rates. The implementation shown in FIG. 1 includes the components needed to process a third signal, which is received from the path 131. The third signal comprises digital samples that represent the audio signal at a third sample rate, such as 192 kHz for example.

The rate converter 114 converts the second signal into a second interim signal comprising digital samples at the third sample rate. Optionally, the rate converter 114 can be applied to the first signal to convert it into the second interim signal. In either implementation, operation of the rate converter 114 may be adapted if desired. If the operation is adapted, parameters that define the operational characteristics are passed along the path 115 to the formatter 108 for assembly into the encoded output signal. If the transmitter 100 can adaptively change the input to the rate converter 114, some indication of the choice of input should be included in the encoded output signal so that the companion receiver 200 can choose the appropriate the input for the rate converter 218.

The subtractor 132 generates a second difference signal comprising samples at the third sample rate by calculating a difference between corresponding samples of the third signal and the second interim signal.

The lossless encoder 136 is applied to the second difference signal received from the subtractor 132 to generate a third encoded signal, which is passed along the path 137 to the formatter 108. The third encoded signal comprises samples that represent the second difference signal at the third sample rate. The lossless encoder 136 adapts its operation in response to third coding parameters whose values can be adjusted to optimize encoder performance. The third coding parameters are passed along the path 138 to the formatter 108.

The formatter 108 assembles the third encoded signal and data representing the third coding parameters into the encoded output signal.

The implementation of the transmitter 100 can be expanded in a similar manner to process signals for four or more signals having different sample rates.

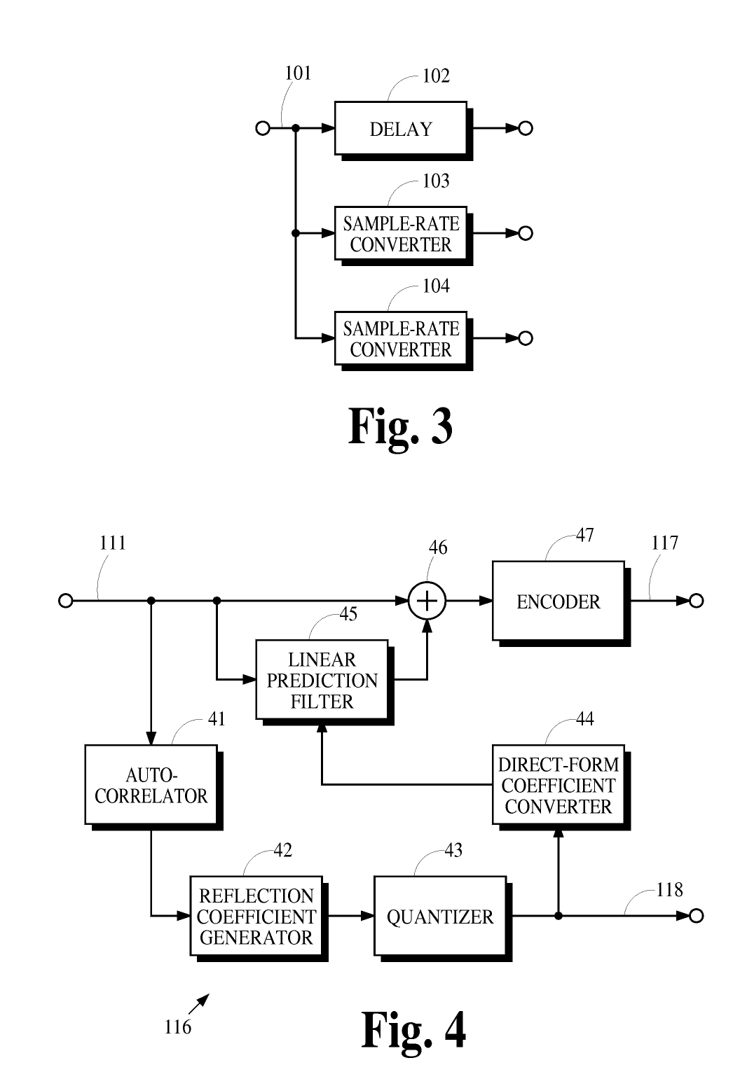

FIG. 3 is a schematic block diagram of a device that may be used separately or incorporated into the transmitter 100 to obtain the first, second and any additional signals such as the third signal from a single source audio signal. The sample-rate converter 103 is applied to the source audio signal received from the path 101 to obtain a signal that represents the source audio signal at a sample rate that differs from the sample rate of the source audio signal. The delay 102 is used to obtain a signal that represents the source audio signal at the same sample rate but is aligned in time with the signal generated by the sample-rate converter 103. The optional sample-rate converter 104 may be used to obtain a signal that represents the source audio signal at a sample rate that differs from the other two sample rates. Each of the sample-rate converters may convert to a higher or a lower sample rate. Additional delay components may be inserted into the signal paths of the two sample-rate converters as needed to provide proper time alignment between all output signals. No additional delay components are necessary, however, if the sample-rate converters 103, 104 are designed to impose delays that are equal to the delay provided by the delay 102. Additional signal processing paths with sample-rate converters may be added if signals with more sample rates are desired.

If the device illustrated in FIG. 3 is used with the transmitter implementation shown in FIG. 1, each of the outputs of the delay 102, the sample-rate converter 103 and the sample-rate converter 104 may be coupled to any of the signal paths 111, 121 and 131. For example, in a two sample-rate system the delay 102 may be coupled to the signal path 111 and the sample-rate converter 103 may be coupled to the signal path 121. Alternatively, in a three sample-rate system the delay 102 may be coupled to the signal path 121, the sample-rate converter 103 may be coupled to the path 131, and the sample-rate converter 104 may be coupled to the signal path 111.

In one implementation, the source audio signal received from the path 101 has a sample rate equal to 48 kHz. The delay 102 passes a delayed replica of the source audio signal as the first signal to the path 111. The sample-rate converter 103 converts the source audio signal into the second signal with a sample rate of 96 kHz and passes this signal to the path 121. If a third sample rate is desired, the sample-rate converter 104 converts the source audio signal into the third signal with a sample rate of 192 kHz and passes this signal to the path 131.

In another implementation, the source audio signal received from path 101 has a sample rate equal to 96 kHz. The delay 102 passes a delayed replica of the source audio signal as the second signal to the path 121. The sample rate converter 103 converts the source audio signal into the first signal with a sample rate of 48 kHz and passes this signal to the path 111. If a third sample rate is desired, the sample rate converter 104 converts the source audio signal into the third signal with a sample rate of 192 kHz and passes this signal to the path 131.

The sample rates and sample-rate conversion factors that are described above are merely exemplary.

2. Receiver

FIG. 2 is a schematic block diagram of one implementation of a receiver for decoding an encoded audio signal that incorporates various aspects of the present invention. Some features illustrated in the figure are optional.

In one variation of this implementation, the receiver 200 receives an encoded audio signal from the path 201. The encoded audio signal conveys a first encoded signal, a second encoded signal, and data that represents first coding parameters and second coding parameters. The first encoded signal represents audio information at a first sample rate, such as 48 kHz for example. The second encoded signal represents audio information at a second sample rate that is higher than the first sample rate, such as 96 kHz for example. The first coding parameters were used by a lossless encoder that generated the first encoded signal. The second coding parameters were used by a lossless encoder that generated the second encoded signal.

The deformatter 202 processes the encoded audio signal in a manner that is appropriate to the information that it contains and extracts whatever information is needed by other components in the receiver 200. The needed information is passed to the appropriate components as described in the following paragraphs.

The lossless decoder 215 is applied to the first encoded signal received from the path 211 and processes it to generate a first signal along the path 216. The lossless decoder 215 adapts its operation in response to the first coding parameters received from the deformatter 202 along the path 212. The values of these parameters can be adjusted by the transmitter 100 to optimize decoder performance. Due to the lossless nature of the coding process, the first signal output by the lossless decoder 215 is identical to the first signal that was input to the lossless encoder 116 in the transmitter 100 that generated the encoded audio signal.

The lossless decoder 225 is applied to the second encoded signal received from the path 221 and processes it to generate a second signal along the path 226. The lossless decoder 225 adapts its operation in response to the second coding parameters received from the deformatter 202 along the path 222. The values of these parameters can be adjusted by the transmitter 100 to optimize decoder performance. Due to the lossless nature of the coding process, the second signal output by the lossless decoder 225 is identical to the second signal that was input to the lossless encoder 126 in the transmitter 100 that generated the encoded audio signal.

The rate converter 217 converts the first signal into a first interim signal comprising digital samples at the second sample rate. The converter 217 operates in such a way that the first interim signal it provides is identical to the first interim signal provided by the rate converter 112 in the transmitter 100 that generated the encoded audio signal.

The summer 228 generates a first summation signal comprising samples at the second sample rate by calculating a sum of corresponding samples of the first interim signal and the second signal.

The selector 208 generates an output audio signal along the path 209 by selecting at least one signal in a set of signals provided by the other components in the receiver 200. In the implementation just described, this set of signals contains the first signal and the first summation signal. By selecting the first signal, the output audio signal represents the source audio signal at the first sample rate. By selecting the first summation signal, the output audio signal represents the source audio signal at the second sample rate.

If desired, the receiver 200 can output an audio signal at only the first sample rate. In this situation, the lossless decoder 225, the rate converter 217, the summer 228 and the selector 208 are not needed. This arrangement is attractive because a receiver 200 that has very limited computation resources can provide a high-quality low-sample-rate signal that was obtained from a very high-quality sample-rate conversion in the receiver 100. If the receiver 200 outputs an audio signal at only the second sample rate, the selector 208 is not needed.

a) Additional Features and Variations

Operation of the rate converter 217 may be adapted. If the operation is adapted, parameters that define the operational characteristics are received from the deformatter 202 along the path 213.

If desired, the receiver 200 may process an encoded audio signal that conveys encoded signals for three or more sample rates. The implementation shown in FIG. 2 includes the components needed to process a third sample rate. In this implementation, the encoded audio signal received from the path 201 also conveys a third encoded signal and data that represents third coding parameters. The third encoded signal represents audio information at a third sample rate that is higher than the first sample rate and not equal to the second rate, such as 192 kHz for example. The third coding parameters were used by a lossless encoder that generated the third encoded signal.

The lossless decoder 235 is applied to the third encoded signal received from the path 231 and processes it to generate a third signal along the path 236. The lossless decoder 235 adapts its operation in response to the third coding parameters received from the deformatter 202 along the path 232. The values of these parameters can be adjusted by the transmitter 100 to optimize decoder performance. Due to the lossless nature of the coding process, the third signal output by the lossless decoder 235 is identical to the third signal that was input to the lossless encoder 136 in the transmitter 100 that generated the encoded audio signal.

The rate converter 218 converts the second signal into a second interim signal comprising digital samples at the third sample rate. The converter 218 operates in such a way that the second interim signal it provides is identical to the second interim signal provided by the rate converter 114 in the transmitter 100 that generated the encoded audio signal.

The rate converter 218 should be applied to the first signal instead if the rate converter 114 in the encoder was applied to the first signal. If the transmitter 100 can adaptively change the input to the rate converter 114, some indication of the choice of input is included in the encoded output signal. The receiver 200 adaptively chooses the appropriate input for the rate converter 218 in response to this indication. The operation of the rate converter 218 may be adapted. If the operation is adapted, parameters that define the operational characteristics are received from the deformatter 202 along the path 223.

The summer 238 generates a second summation signal comprising samples at the third sample rate by calculating a sum of corresponding samples of the second interim signal and the third signal.

The implementation of the receiver 200 can be expanded in a similar manner to process signals for four or more signals having different sample rates.

B. Additional Details of Implementation

1. Lossless Encoder

The lossless encoders of the transmitter 100 may be implemented in a variety of ways. Although the choice of implementation may have significant effects on coding performance, no particular implementation of a lossless encoder is essential to the present invention.

One implementation is illustrated by the schematic block diagram of FIG. 4. The figure refers to the lossless encoder 116 but the lossless encoders 126 and 136 may be implemented in the same way. In this implementation, the encoder input signal is received from the path 111. The autocorrelator 41 analyzes the input signal to obtain measures of similarity between digital samples at varying sample offsets.

The resulting measures of sample similarity are used by the reflection coefficient generator 42 to generate a set of reflection coefficients for the linear prediction filter 45. The reflection coefficient generator 42 uses the Levinson-Durbin algorithm to derive a set of reflection coefficients for the prediction filter 45 such that the energy of the prediction error signal is minimized This error signal is the difference between the input signal received from the path 111 and the filter's prediction of the input signal. The reflection coefficients are quantized by the quantizer 43 and passed along the path 118.

The quantized reflection coefficients provide a complete description of the prediction filter but they must be converted into direct-form coefficients to implement the prediction filter as a finite impulse response (FIR) filter. The direct-form coefficient converter 44 performs this conversion and passes the direct-form coefficients to the linear prediction filter 45. Each of the direct-form coefficients is the coefficient for a respective tap in an FIR filter.

Samples from the output of the filter 45 are added to samples of the input signal by the summer 46. The samples obtained from this summation is the prediction-error signal, which is passed to the encoder 47 for encoding. It may be helpful to explain that the summer 46 provides at its output a difference between the input signal and the predicted signal because the signs of the filter coefficients received from the direct-form coefficient converter 44 cause the linear prediction filter 45 to generate a prediction signal that is inverted relative to the input signal.

Additional details about this particular implementation of prediction filters may be obtained from Proakis and Manolakis, “Digital Signal Processing Principles, Algorithms, and Applications,” Prentice Hall, International Editions, 3rd edition, which is incorporated herein by reference. See especially pp 327-329, 503, 504, 512 and 865-868.

The encoder 47 applies an encoding process to the prediction-error signal and passes the encoded representation along the path 117. Preferably, the encoding process is an entropy coding process such as arithmetic coding or Huffman coding.

Other implementations of a lossless encoder are described in U.S. Pat. No. 6,664,913 entitled “Lossless Coding Method for Waveform Data” issued Dec. 16, 2003, which is incorporated herein by reference.

2. Lossless Decoder

The lossless decoders of the receiver 200 may also be implemented in a variety of ways but their implementation should be complementary to the implementation of the lossless encoders in the transmitter 100 so that the end-to-end coding effect of the encoders and decoders is lossless.

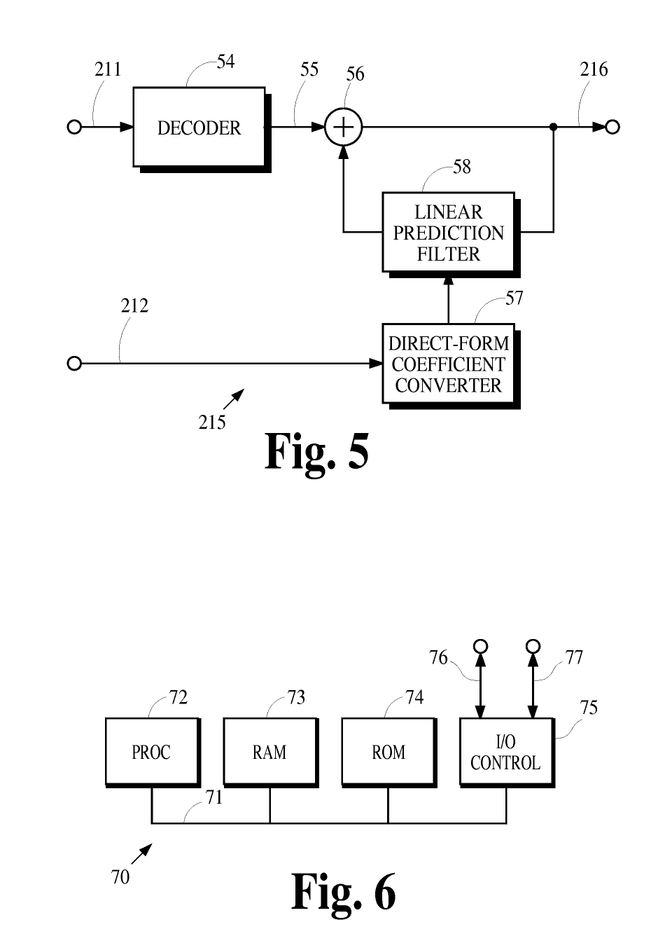

One implementation of a lossless decoder that is complementary to the lossless encoder implementation described above is illustrated by the schematic block diagram of FIG. 5. The figure refers to the lossless decoder 215 but the lossless encoders 225 and 235 may be implemented in the same way. In this implementation, the encoded audio signal is received from the path 211. The decoder 54 applies a decoding process to the encoded audio signal and passes the decoded representation along the path 55. Preferably, the encoding process is an entropy coding process such as arithmetic coding or Huffman coding that is a suitable inverse of the encoding process applied by the encoder 47 in the transmitter 100 that generated the encoded audio signal.

The direct-form coefficient converter 57 receives quantized reflection coefficients from the path 212 and converts them into direct-form coefficients, which in turn are passed to the linear prediction filter 58. Each of the direct-form coefficients is the coefficient for a respective tap in an FIR filter.

Samples from the output of the filter 58 are added to samples of the decoded signal by the summer 56. The samples obtained from this summation comprise the predicted signal, which is passed along the path 216 and input to the linear prediction filter 58.

Additional details may be obtained from Proakis and Manolakis, cited above.

Other implementations of a lossless decoder are described in U.S. Pat. No. 6,664,913, cited above.

3. Sample-Rate Conversion

Conversion of sample rates is performed in the rate converters 112 and 114 of the transmitter 100 and the rate converters 217 and 218 of the receiver 200, as well as in the sample-rate converters 103 and 104 illustrated in FIG. 3.

Sample rate conversion may be achieved by interpolation between samples to increase the sample rate by some integer factor, decimation of samples to reduce the sample rate by some integer factor, or a combination of interpolation followed by decimation to achieve a change in sample rate by a factor that is rational but not an integer. These operations can be implemented by FIR filters using known techniques. Additional details can be obtained from Proakis and Manolakis, “Introduction to Digital Signal Processing,” Macmillan Publishing Co., 1988, which is incorporated herein by reference. See especially pages 654-673.

The quality or accuracy of the sample-rate conversion can vary significantly according to the type and design of the filter used to perform the conversion. Higher-quality conversions generally require longer filters, which require more computational resources than shorter filters that provide lower-quality conversions.

In preferred implementations, a high-quality sample-rate conversion should be performed in the sample-rate converters 103 and 104. A lower quality conversion is acceptable in the remaining converters shown in FIGS. 1 and 2 but complementary conversions in the transmitter 100 and the receiver 200 should achieve exactly the same results. The first interim signal obtained from the rate converter 112 should be identical to the first interim signal obtained from the rate converter 217 and the second interim signal obtained from the rate converter 114 should be identical to the second interim signal obtained from the rate converter 218.

In one implementation, a half-band FIR filter is used to implement the rate converters shown in FIGS. 1 and 2 when converting to a higher rate. The sample-rate converters shown in FIG. 3 are implemented by high-order FIR filters with 128 taps.

C. Implementation

Devices that incorporate various aspects of the present invention may be implemented in a variety of ways including software for execution by a computer or some other device that includes more specialized components such as digital signal processor (DSP) circuitry coupled to components similar to those found in a general-purpose computer. FIG. 6 is a schematic block diagram of a device 70 that may be used to implement aspects of the present invention. The processor 72 provides computing resources. RAM 73 is system random access memory (RAM) used by the processor 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device having a storage medium such as magnetic tape or disk, or an optical medium. The storage medium may be used to record programs of instructions for operating systems, utilities and applications, and may include programs that implement various aspects of the present invention.

Means for performing the functions required to practice various aspects of the present invention can be electronic components that are implemented in a wide variety of ways including discrete logic components, integrated circuits, one or more ASICs and/or program-controlled processors. Programs that implement the present invention by execution in a program-controlled processor may be designed using conventional program design methodologies and written in conventional programming languages. The manner in which these components and programs are implemented is not important to the present invention.

Program implementations of the present invention may be conveyed by a variety of machine readable media including storage media, which are non-transitory media that record information using essentially any recording technology including magnetic tape, cards or disk, optical cards or disc, and detectable markings on media including paper.

1-41. (canceled)

42. A method for encoding an audio signal, wherein the method comprises:
obtaining a first signal comprising digital samples that represent the audio signal at a first sample rate; wherein the first signal is obtained from a delay of an input signal comprising digital samples that represent the audio signal at the first sample rate;
obtaining a second signal comprising digital samples that represent the audio signal at a second sample rate that is higher than the first sample rate; wherein the second digital signal is obtained from a sample-rate conversion of the input signal;
converting the first signal into a first interim signal comprising digital samples at the second sample rate; wherein a quality of the sample-rate conversion for obtaining the first interim signal is lower than a quality of the sample-rate conversion for obtaining the second digital signal;
generating a first difference signal comprising samples at the second sample rate that represent a difference between corresponding samples of the second signal and the first interim signal;
applying a first lossless encoder to the first signal to generate a first encoded signal comprising samples representing the first signal at the first sample rate, wherein the first lossless encoder adapts its operation in response to first coding parameters;
applying a second lossless encoder to the first difference signal to generate a second encoded signal comprising samples representing the first difference signal at the second sample rate, wherein the second lossless encoder adapts its operation in response to second coding parameters; and
generating an encoded output signal that conveys the first encoded signal, the second encoded signal, and representations of the first coding parameters and the second coding parameters.

43. The method of claim 42 that comprises:
obtaining a third signal comprising digital samples that represent the audio signal at a third sample rate that is higher than the second sample rate;
converting either the first or the second signal into a second interim signal comprising digital samples at the third sample rate;
generating a second difference signal comprising samples at the third sample rate that represent a difference between corresponding samples of the third signal and the second interim signal;
applying a third lossless encoder to the second difference signal to generate a third encoded signal comprising samples representing the second difference signal at the third sample rate, wherein the third lossless encoder adapts its operation to third coding parameters; and
generating the encoded output signal so that it also conveys the third encoded signal and a representation of the third coding parameters.

44. The method of claim 43 that comprises:
obtaining the third digital signal from a sample-rate conversion of either the input signal or the second signal.

45. The method of claim 44 that comprises:
applying the first lossless encoder to the first signal to generate a first prediction error signal and applying an entropy encoder to the first prediction error signal to generate the first encoded signal, wherein generation of the first prediction error signal comprises applying a first prediction filter to the first signal, and wherein the first lossless encoder adapts its operation by adapting the first prediction filter in response to the first coding parameters that represent prediction filter coefficients;
applying the second lossless encoder to the first difference signal to generate a second prediction error signal and applying an entropy encoder to the second prediction error signal to generate the second encoded signal, wherein generation of the second prediction error signal comprises applying a second prediction filter to the first difference signal, and wherein the second lossless encoder adapts its operation by adapting the second prediction filter in response to the second coding parameters that represent prediction filter coefficients; and
applying the third lossless encoder by to the second difference signal to generate a third prediction error signal and applying an entropy encoder to the third prediction error signal to generate the third encoded signal, wherein generation of the third prediction error signal comprises applying a third prediction filter to the second difference signal, and wherein the third lossless encoder adapts its operation by adapting the third prediction filter in response to the third coding parameters that represent prediction filter coefficients.

46. The method of claim 42 that comprises:
applying the first lossless encoder to the first signal to generate a first prediction error signal and applying an entropy encoder to the first prediction error signal to generate the first encoded signal, wherein generation of the first prediction error signal comprises applying a first prediction filter to the first signal, and wherein the first lossless encoder adapts its operation by adapting the first prediction filter in response to the first coding parameters that represent prediction filter coefficients; and
applying the second lossless encoder to the first difference signal to generate a second prediction error signal and applying an entropy encoder to the second prediction error signal to generate the second encoded signal, wherein generation of the second prediction error signal comprises applying a second prediction filter to the first difference signal, and wherein the second lossless encoder adapts its operation by adapting the second prediction filter in response to the second coding parameters that represent prediction filter coefficients.

47. An apparatus (100) for encoding an audio signal, wherein the apparatus comprises:
a first terminal (111) that receives a first signal comprising digital samples that represent the audio signal at a first sample rate;
a delay (102) that provides the first signal to the first terminal (111) as a delayed version of an input signal, wherein the input signal comprises digital samples that represent the audio signal at the first sample rate;
a second terminal (121) that receives a second signal comprising digital samples that represent the audio signal at a second sample rate that is higher than the first sample rate;
a sample-rate converter (103) that provides the second signal to the second terminal by converting the input signal to the second sample rate;
a first sample-rate converter (112) coupled to the first terminal (111) to convert the first signal into a first interim signal comprising digital samples at the second sample rate; wherein a quality of the sample-rate conversion for obtaining the first interim signal is lower than a quality of the sample-rate conversion for obtaining the second signal;
a first difference calculator (122) coupled to the first sample-rate converter (112) and the second terminal (121) to generate a first difference signal comprising samples at the second sample rate that represent a difference between corresponding samples of the second signal and the first interim signal;
a first lossless encoder (116) coupled to the first terminal (111) to be applied to the first signal to generate a first encoded signal comprising samples representing the first signal at the first sample rate, wherein the first lossless encoder (111) adapts its operation in response to first coding parameters;
a second lossless encoder (126) coupled to the first difference calculator (122) to be applied to the first difference signal to generate a second encoded signal comprising samples representing the first difference signal at the second sample rate, wherein the second lossless encoder adapts its operation in response to second coding parameters; and
a formatter (108) coupled to the first lossless encoder (116) and the second lossless encoder (126) to generate an encoded output signal that conveys encoded representations of the first encoded signal, the second encoded signal, the first coding parameters and the second coding parameters.

48. The apparatus (100) of claim 47 that comprises:
a third terminal (131) that receives a third signal comprising digital samples that represent the audio signal at a third sample rate that is higher than the second sample rate;
a second sample-rate converter (114) that either is coupled to the first terminal (111) to convert the first signal into a second interim signal comprising digital samples at the third sample rate or is coupled to the second terminal (121) to convert the second signal into the second interim signal;
a second difference calculator (132) coupled to second sample-rate converter (114) and the third terminal (131) to generate a second difference signal comprising samples at the third sample rate that represent a difference between corresponding samples of the third signal and the second interim signal;
a third lossless encoder (136) coupled to the second difference calculator (132) to be applied to the second difference signal to generate a third encoded signal comprising samples representing the second difference signal at the third sample rate, wherein the third lossless encoder adapts its operation in response to third coding parameters; and
the formatter (108) coupled to the third lossless encoder (136) to generate the encoded output signal so that it also conveys encoded representations of the third encoded signal and the third coding parameters.

49. The apparatus (100) of claim 48 that comprises:
a second sample-rate converter (104) that provides the third signal to the third terminal (131) by converting either the input signal or the second signal to the third sample rate.

50. The apparatus (100) of claim 48, wherein:
the first lossless encoder (116) comprises a first prediction filter (45) coupled to the first terminal (111) and a first entropy encoder (47) coupled to the first prediction filter (45) to generate the first encoded signal, wherein the first prediction filter (45) adapts its operation in response to the first coding parameters that represent prediction filter coefficients;
the second lossless encoder (126) comprises a second prediction filter coupled to the first difference calculator (122) and a second entropy encoder coupled to the second prediction filter to generate the second encoded signal, wherein the second prediction filter adapts its operation in response to the second coding parameters that represent prediction filter coefficients; and
the third lossless encoder (136) comprises a third prediction filter coupled to the second difference calculator (132) and a third entropy encoder coupled to the third prediction filter to generate the third encoded signal, wherein the third prediction filter adapts its operation in response to the third coding parameters that represent prediction filter coefficients.

51. The apparatus (100) of claim 47 that comprises:
the first lossless encoder (116) comprises a first prediction filter (45) coupled to the first terminal (111) and a first entropy encoder (47) coupled to the first prediction filter (45) to generate the first encoded signal, wherein the first prediction filter (45) adapts its operation in response to the first coding parameters that represent prediction filter coefficients; and
the second lossless encoder (126) comprises a second prediction filter coupled to the first difference calculator (122) and a second entropy encoder coupled to the second prediction filter to generate the second encoded signal, wherein the second prediction filter adapts its operation in response to the second coding parameters that represent prediction filter coefficients.

52. A method for decoding an encoded audio signal, wherein the method comprises:
receiving the encoded audio signal that conveys a first encoded signal comprising samples representing audio information at a first sample rate, a second encoded signal comprising samples that represent audio information at a second sample rate that is higher than the first sample rate, wherein the audio information at the second sample rate represents a difference between a first audio signal generated by a first sample rate conversion of an audio input signal from the first sample rate to the second sample rate and a second audio signal generated by a second sample rate conversion of a delayed version of the audio input signal from the first sample rate to the second sample rate, wherein a quality of the first sample rate conversion is higher than a quality of the second sample rate conversion, and representations of first coding parameters of a first lossless encoder that was used to generate the first encoded signal and second coding parameters of a second lossless encoder that was used to generate the second encoded signal;
processing the encoded audio signal to obtain the first encoded signal, the second encoded signal, and the representations of the first coding parameters and the second coding parameters;
generating a first decoded signal by applying a first lossless decoder to the first encoded signal, wherein the first lossless decoder adapts its operation in response to the first coding parameters;
generating a second decoded signal by applying a second lossless decoder to the second encoded signal, wherein the second lossless decoder adapts its operation in response to the second coding parameters;
converting the first decoded signal into a first interim signal comprising digital samples at the second sample rate;
generating a first summation signal comprising samples at the second sample rate that represent a sum of corresponding samples of the first interim signal and the second decoded signal; and
generating an output signal from at least one signal in a set of signals comprising the first decoded signal and the first summation signal, wherein the first decoded signal comprises digital samples that represent an audio signal at the first sample rate and the first summation signal comprises digital samples that represent the audio signal at the second sample rate.

53. An apparatus for decoding an encoded audio signal, wherein the apparatus comprises:
means for receiving the encoded audio signal that conveys a first encoded signal comprising samples representing audio information at a first sample rate, a second encoded signal comprising samples that represent audio information at a second sample rate that is higher than the first sample rate, wherein the audio information at the second sample rate represents a difference between a first audio signal generated by a first sample rate conversion of an audio input signal from the first sample rate to the second sample rate and a second audio signal generated by a second sample rate conversion of a delayed version of the audio input signal from the first sample rate to the second sample rate, wherein a quality of the first sample rate conversion is higher than a quality of the second sample rate conversion, and representations of first coding parameters of a first lossless encoder that was used to generate the first encoded signal and second coding parameters of a second lossless encoder that was used to generate the second encoded signal;
means for processing the encoded audio signal to obtain the first encoded signal, the second encoded signal, and the representations of the first coding parameters and the second coding parameters;
means for generating a first decoded signal by applying a first lossless decoder to the first encoded signal, wherein the first lossless decoder adapts its operation in response to the first coding parameters;
means for generating a second decoded signal by applying a second lossless decoder to the second encoded signal, wherein the second lossless decoder adapts its operation in response to the second coding parameters;
means for converting the first decoded signal into a first interim signal comprising digital samples at the second sample rate;
means for generating a first summation signal comprising samples at the second sample rate that represent a sum of corresponding samples of the first interim signal and the second decoded signal; and
means for generating an output signal from at least one signal in a set of signals comprising the first decoded signal and the first summation signal, wherein the first decoded signal comprises digital samples that represent an audio signal at the first sample rate and the first summation signal comprises digital samples that represent the audio signal at the second sample rate.

54. A non-transitory computer readable storage medium that is readable by a device and that records a program of instructions executable by the device to perform a method for encoding an audio signal, where the method comprises:
obtaining a first signal comprising digital samples that represent the audio signal at a first sample rate; wherein the first signal is obtained from a delay of an input signal comprising digital samples that represent the audio signal at the first sample rate;
obtaining a second signal comprising digital samples that represent the audio signal at a second sample rate that is higher than the first sample rate; wherein the second digital signal is obtained from a sample-rate conversion of the input signal;
converting the first signal into a first interim signal comprising digital samples at the second sample rate; wherein a quality of the sample-rate conversion for obtaining the first interim signal is lower than a quality of the sample-rate conversion for obtaining the second digital signal;
generating a first difference signal comprising samples at the second sample rate that represent a difference between corresponding samples of the second signal and the first interim signal;
applying a first lossless encoder to the first signal to generate a first encoded signal comprising samples representing the first signal at the first sample rate, wherein the first lossless encoder adapts its operation in response to first coding parameters;
applying a second lossless encoder to the first difference signal to generate a second encoded signal comprising samples representing the first difference signal at the second sample rate, wherein the second lossless encoder adapts its operation in response to second coding parameters; and
generating an encoded output signal that conveys the first encoded signal, the second encoded signal, and representations of the first coding parameters and the second coding parameters.

55. A non-transitory computer readable storage medium that is readable by a device and that records a program of instructions executable by the device to perform a method for decoding an encoded audio signal, where the method comprises:
receiving the encoded audio signal that conveys a first encoded signal comprising samples representing audio information at a first sample rate, a second encoded signal comprising samples that represent audio information at a second sample rate that is higher than the first sample rate, wherein the audio information at the second sample rate represents a difference between a first audio signal generated by a first sample rate conversion of an audio input signal from the first sample rate to the second sample rate and a second audio signal generated by a second sample rate conversion of a delayed version of the audio input signal from the first sample rate to the second sample rate, wherein a quality of the first sample rate conversion is higher than a quality of the second sample rate conversion, and representations of first coding parameters of a first lossless encoder that was used to generate the first encoded signal and second coding parameters of a second lossless encoder that was used to generate the second encoded signal;
processing the encoded audio signal to obtain the first encoded signal, the second encoded signal, and the representations of the first coding parameters and the second coding parameters;
generating a first decoded signal by applying a first lossless decoder to the first encoded signal, wherein the first lossless decoder adapts its operation in response to the first coding parameters;
generating a second decoded signal by applying a second lossless decoder to the second encoded signal, wherein the second lossless decoder adapts its operation in response to the second coding parameters;
converting the first decoded signal into a first interim signal comprising digital samples at the second sample rate;
generating a first summation signal comprising samples at the second sample rate that represent a sum of corresponding samples of the first interim signal and the second decoded signal; and
generating an output signal from at least one signal in a set of signals comprising the first decoded signal and the first summation signal, wherein the first decoded signal comprises digital samples that represent an audio signal at the first sample rate and the first summation signal comprises digital samples that represent the audio signal at the second sample rate.
